(19) United States
(12) Patent Application Publication
(10) Pub. No.: US 2015/0248754 A1
(43) Pub. Date: Sep. 3, 2015

(54) Method and Device for Monitoring at Least One Interior Space of a Building, and Assistance System for at Least One Interior Space of a Building

(71) Applicant: Robert Bosch GmbH, Stuttgart (DE)

(72) Inventors: Kathrin Graner, Fellbach (DE); Henning Hayn, Stuttgart (DE); Micheal Krueger, Reutlingen (DE); Roland Klinnert, Korntal-Muenchingen (DE); Ingo Herrmann, Friolzheim (DE); Peter Theunissen, Beilstein (DE); Merce Mueller-Gorchs, Weil Der Stadt (DE)

(21) Appl. No.: 14/627,114

(22) Filed: Feb. 20, 2015

(30) Foreign Application Priority Data
Feb. 28, 2014 (DE) 10 2014 203 749.2

(51) Int. Cl. G06T 7/00; H04N 5/33; G06T 7/20

(52) U.S. Cl. CPC G06T 7/004; G06T 7/2033; H04N 5/33; G06T 2207/30232; G06T 2207/10048

(57) ABSTRACT

A method for monitoring at least one interior space of a building includes comparing recorded image data, which represent the at least one interior space, with reference data, which represent a reference situation, in order to generate monitoring information dependent on a comparison result. The monitoring information represents a monitoring-relevant situation in the at least one interior space.

This application claims priority under 35 U.S.C. §119 to patent application no. DE 10 2014 203 749.2, filed on Feb. 28, 2014 in Germany, the disclosure of which is incorporated herein by reference in its entirety.

The present disclosure relates to a method for monitoring at least one interior space of a building, to a corresponding device and to a corresponding computer program product, and to an assistance system for at least one interior space of a building.

### BACKGROUND

Emergency home call systems are technical systems by means of which elderly or disabled persons in particular may place an emergency call to a switchboard. An emergency call may be activated manually by means of a pushbutton or automatically by means of sensors, e.g. fall sensors.

### SUMMARY

Against this background, the approach presented here presents a method for monitoring at least one interior space of a building, furthermore a device which employs this method and, finally, a corresponding computer program product and, finally, an assistance system for at least one interior space of a building in accordance with the main claims. Advantageous embodiments emerge from the respective dependent claims and the following description.

In accordance with embodiments of the present disclosure, at least one interior space of a building can be monitored in respect of a presence of a situation which is defined as relevant for the monitoring, in particular by analyzing image data. In particular, a camera system or an optical sensor system can be used or provided here for interior space monitoring. Here, use can be made of e.g. an optical sensor in the home or domestic environment, wherein an assistance system or assistance functions can be implemented by automated evaluation of sensor signals, for example per domicile or per room, from one or more sensors.

Advantageously, at least one interior space of a building can be monitored reliably and accurately in accordance with embodiments of the present disclosure. Here, monitoring-relevant situations can be reliably identified and distinguished from one another in this case, in particular by automated optical monitoring. An identification of situations within the meaning of maintaining, or deviating from, normal situations can be improved. Here, in particular, it is also possible to increase robustness of the monitoring such that an occurrence of false alarms can be reduced. Moreover, multifaceted assistance and comfort systems, which are based on reliable situation identification or room monitoring, can be realized.

A method for monitoring at least one interior space of a building is presented, wherein the method includes the following step:

Comparing recorded image data, which represent the at least one interior space, with reference data, which represent a reference situation (defined as normal or abnormal), in order to generate monitoring information dependent on a comparison result, which monitoring information represents a monitoring-relevant situation in the at least one interior space.

Within the comparison step, the monitoring information can be generated in this case if the image data deviate from reference data which represent a reference situation defined as normal. The monitoring information can also be generated in the comparison step if the image data at least partly correspond to reference data which represent a reference situation defined as abnormal. Here, the monitoring-relevant situation can be a situation which, in accordance with a designated monitoring target, is defined as being relevant. The method can include a step of reading the recorded image data and the reference data. The method can also include a step of recording the image data.

Here, infrared image data recorded by an infrared camera can be used as the recorded image data in the comparison step. The infrared camera can be a camera or thermal camera for depicting thermal radiation, as is used for e.g. temperature measuring instruments or night vision instruments. The infrared camera can be embodied to be effective in the far infrared. The infrared image data can represent image data recorded in the far infrared range. Such an embodiment provides the advantage that an infrared image protects the privacy of occupants of the building to significantly greater extent than an image in the visible light range. Moreover, infrared cameras are insensitive to brightness differences and also operate in the darkness. Significantly more information can be extracted from the images of an infrared sensor or an infrared camera by means of image processing than from signals of simple motion detectors, for example information for identifying a person, counting objects or persons, directional information, temperature information etc.

Therefore, compared to some known sensors, such as e.g. motion detectors or cameras recording in the visible light range, what can advantageously be achieved by using infrared image data or by means of an infrared camera is that, for example, encroachments into the privacy of persons are avoided, a sensitivity in relation to brightness changes is removed or reduced, an identification of stationary persons is made possible, etc. In particular, computational complexity during the image processing can be reduced compared with cameras in the visible light range, e.g. using CCD or CMOS technology, and a sensitivity in relation to changing light conditions can be reduced. Infrared cameras can provide meaningful image data even in the case of darkness. Infrared cameras avoid an encroachment into the privacy of the occupants. Moreover, infrared cameras can be available in a cost-effective manner. Compared to conventional motion detectors, which are based on e.g. radar, ultrasound or infrared technology, infrared cameras can provide sensor data with high information content. Furthermore, it is possible to distinguish between different persons or occupants of the building, e.g. husband, wife, care staff, by using infrared image data. Moreover, pets can be reliably identified and such immunity to pets can reduce susceptibility to faults during the monitoring and can increase robustness. Also, the movement direction of persons or objects can be identified when using infrared image data; for example, it is possible to distinguish between entering and leaving the at least one room. Furthermore, a stationary state of an object, for example in the case of an unconscious person, can also be identified when using infrared image data.

In accordance with one embodiment, the image data can be compared with reference data in the comparison step, which reference data represent at least one object pattern, in order to identify at least one object represented by the image data, which represents a person, an animal or an article. Therefore, object identification can be performed using reference data and recorded image data. Here, objects can be identified and distinguished from one another such that robustness and accuracy of the method can be increased. In particular, it is also possible to distinguish between individual persons. Here, the high accuracy is an important quality feature, since a robust classification of situations is possible, in particular also in the case of households with a number of occupants.

Here, first image data can be compared with second image data, which are recorded offset by a time interval in relation to the first image data, in the comparison step in order to determine a position, a movement, a speed and, additionally or alternatively, a behavior of a person identified in the image data. To this end, a relationship or deviation between the first image data and the second image data can be determined in the region of the person identified in the image data. Such an embodiment offers the advantage that, in particular, there can be identification, including speed and movement direction, of getting-up processes and monitoring of activities of the day-to-day life of at least one person.

Therefore, in particular, an improvement of classification of situations, within the meaning of situational awareness, for the earliest possible identification of inactivity or deviation from normal behavior and a reduction of false alarms can be achieved, for example, inter alia, by the identification of persons, improved distinction between entry and exit of a room, and the identification that a domicile is left or that occupants return home again, and as a result of a pet immunity, and by an extension of the monitoring to households with a number of persons. For such an extension, single person models can be learnt, which can then be used separately or in any combination during application. The term situational awareness can be understood to mean automatic evaluation of sensor data for determining a current state of occupants and/or their surroundings.

Moreover, first image data can be compared with second image data, which are recorded offset by a time interval in relation to the first image data, in the comparison step in order to determine the difference between values of at least one pixel represented in the first image data and in the second image data. Here, the monitoring information can be generated dependent on a comparison of the difference with a threshold. Such an embodiment offers the advantage that, in particular, dangerous or potentially dangerous monitoring-relevant situations can be identified reliably and in an uncomplicated manner, and can be distinguished from harmless situations.

Here, the threshold can be related to the time interval, to a maximum value of the at least one pixel, to a minimum value of the at least one pixel, to a value gradient of the at least one pixel, to a mean value of a plurality of pixels and, additionally or alternatively, to a position of the at least one pixel. Such an embodiment offers the advantage that, due to the multiplicity of reference values, to which the threshold can relate, it is also possible to reliably identify a multiplicity of situations.

Furthermore, the method can include a step of generating the reference data using predefined pattern data, compared image data, at least one item of monitoring information and, additionally or alternatively, surroundings data of the at least one interior space. Here, the reference data can be trained in the generation step. By way of example, the surroundings data can relate to weather data or the like. Such an embodiment offers the advantage that reference data, which enable precise identification of monitoring-relevant situations, which is matched to a multiplicity of applications, are available or can be provided.

Moreover, the method can include a step of emitting warning information and, additionally or alternatively, action information for rectifying the monitoring-relevant situation dependent on the monitoring information. Here, the warning information and, additionally or alternatively, the action information can be generated using the monitoring information. The warning information can be embodied to cause an alarm in the case of processing by a suitable device within, or outside of, the building, wherein the alarm may include an automatically performable command, a message, an acoustic alarm signal and, additionally or alternatively, an optical alarm signal or the like. The action information can be embodied to cause output of an acoustic message and, additionally or alternatively, an optical message within, or outside of, the building in the case of processing by a suitable device. Such an embodiment offers the advantage that, in response to identification of a critical monitoring-relevant situation, e.g. a motionless person, an alarm can be triggered automatically or countermeasures can be introduced or requested.

The approach presented here furthermore develops a device which is embodied to perform or implement the steps of one variant of a method presented here in appropriate apparatuses. This embodiment variant of the disclosure in the form of a device can also quickly and efficiently achieve the objective underlying the disclosure.

In the present case, a device can be understood to mean an electrical instrument, which processes sensor signals and, dependent thereon, outputs control signals and/or data signals. The device can include an interface, which can be embodied in terms of hardware and/or software. In the case of a hardware-type embodiment, the interfaces can for example be part of a so-called system ASIC, which contains very different functions of the device. However, it is also possible for the interfaces to be dedicated integrated circuits or to at least partly consist of discrete components. In the case of a software-type embodiment, the interfaces can be software modules which, for example, are present on a microcontroller in addition to other software modules.

Furthermore, an assistance system for at least one interior space of a building is presented, wherein the assistance system includes the following features:

at least one camera, which is arranged in the at least one interior space, wherein the at least one camera is embodied for recording and providing image data; and

an embodiment of the aforementioned device, which is connected to the at least one camera in a data transmission-capable manner.

The assistance system can be an emergency home call system or the like. In the building, at least one camera per interior space can be arranged in at least one interior space. In conjunction with the assistance system, one embodiment of the monitoring device mentioned above can advantageously be employed or used. Here, a multiplicity of monitoring functions can advantageously be carried out by using the at least one camera and the monitoring device, which monitoring functions are conventionally carried out by a plurality of sensors, e.g. fire alarms, gas sensors, motion detectors, cameras etc. Hence, assistance, safety and comfort functions can be realized which, for example, are also known by the term ambient assisted living.

In accordance with one embodiment, the device can be embodied as part of the at least one camera or as a separate device which is separate from the at least one camera. The separate device can be arranged in the building. Such an embodiment offers the advantage that the main monitoring functions can be carried out in the building itself, and so a connection to the outside is not mandatory.

Moreover, the assistance system can include a base station arranged in the building and a server arranged separately from the building. Here, the base station can be connected to the at least one camera in a data transmission-capable manner. The server can be connected to the base station in a data transmission-capable manner. Here, the base station can be arranged in the building. Moreover, the server can be connected in a data transmission-capable manner to at least one further base station in at least one further building. Here, the device can be embodied as part of the base station or as part of the server. Such an embodiment offers the advantage that monitoring or image evaluation can take place centrally for one building or for a plurality of buildings.

A computer program product or computer program comprising program code, which can be stored on a machine-readable medium or storage medium such as a semiconductor storage, a hard disk drive or an optical storage, and which is used for performing, implementing and/or actuating the steps of the method according to one of the embodiments described above, in particular if the program product or the program is carried out on a computer or a device, is also advantageous.

### BRIEF DESCRIPTION OF THE DRAWINGS

The approach presented here is explained in more detail below in an exemplary manner on the basis of the attached drawings. In detail:

FIG. 1 shows a flowchart of a method for monitoring at least one interior space of a building in accordance with one exemplary embodiment of the present disclosure;

FIG. 2 shows a schematic illustration of an assistance system for at least one interior space of a building in accordance with one exemplary embodiment of the present disclosure;

FIG. 3 shows a schematic illustration of an assistance system in accordance with one exemplary embodiment of the present disclosure in a building;

FIG. 4 shows an image of a number of persons, recorded by an infrared camera;

FIG. 5 shows a flowchart for object identification in a method for monitoring at least one interior space of a building in accordance with one exemplary embodiment of the present disclosure;

FIG. 6 shows a flowchart for classifying situations in a method for monitoring at least one interior space of a building in accordance with one exemplary embodiment of the present disclosure; and

FIGS. 7A to 7F show images of persons in different situations, recorded by an infrared camera.

### DETAILED DESCRIPTION

In the following description of expedient exemplary embodiments of the present disclosure, the same or similar reference signs are used for the elements which are depicted in the various figures and have a similar effect, wherein a repeated description of these elements is dispensed with.

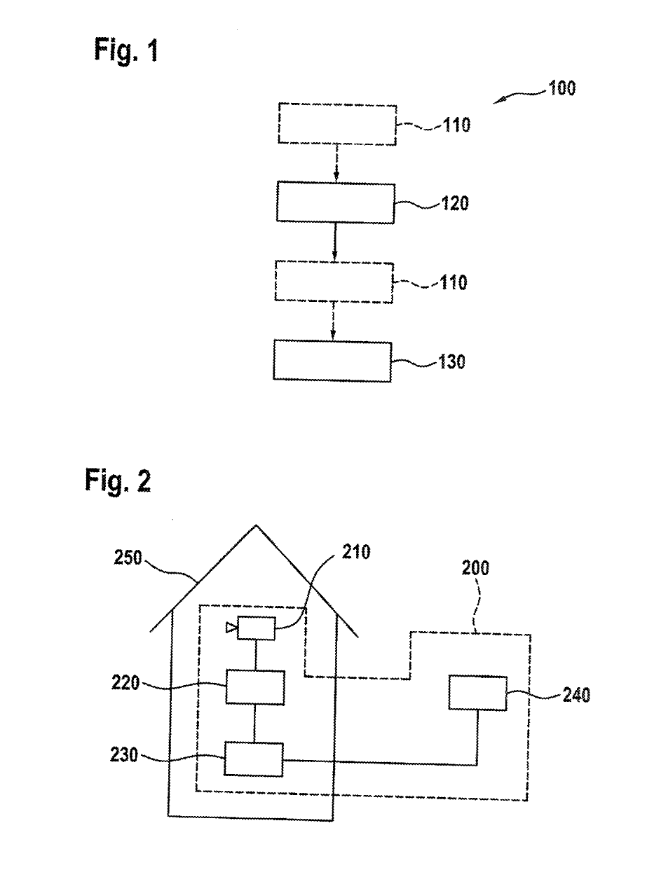

FIG. 1 shows a flowchart of a method 100 for monitoring at least one interior space of a building in accordance with one exemplary embodiment of the present disclosure. The method 100 includes a step 110 of generating reference data, which represent a reference situation defined as normal or abnormal, using predefined pattern data, compared image data, at least one item of monitoring information and, additionally or alternatively, surroundings data of the at least one interior space. Moreover, the method 100 includes a step 120 of comparing recorded image data, which represent the at least one interior space, with the reference data in order to generate monitoring information dependent on a comparison result, which monitoring information represents a monitoring-relevant situation in the at least one interior space. The method 100 further includes a step 130 of emitting warning information and, additionally or alternatively, action information for rectifying the monitoring-relevant situation dependent on the monitoring information.

In accordance with one exemplary embodiment of the present disclosure, infrared image data recorded by an infrared camera are used as the recorded image data in the comparison step 120.

Here, the generation step 110 can be performed prior to and, additionally or alternatively, after the comparison step 120. Optionally, the generation step 110 and, additionally or alternatively, the emission step 130 can also be bypassed. Therefore, the method 100 may include a sequence of steps which, in accordance with one exemplary embodiment, comprises the generation step 110, the comparison step 120 and the emission step 130, which, in accordance with a further exemplary embodiment, comprises the comparison step 120, the generation step 110 and the emission step 130, which, in accordance with an even further exemplary embodiment, comprises the generation step 110, the comparison step 120, the generation step 110 and the emission step 130, which, in accordance with a further exemplary embodiment, comprises the comparison step 120 and the emission step 130 and which, in accordance with an even further exemplary embodiment, comprises the comparison step 120.

In accordance with one exemplary embodiment, the image data can be compared with reference data in the comparison step 120, which reference data represent at least one object pattern, in order to identify at least one object represented by the image data, which represents a person, an animal and/or an article.

Here, in accordance with one exemplary embodiment, first image data can be compared with second image data, which are recorded offset by a time interval in relation to the first image data, in the comparison step 120 in order to determine a position, a movement, a speed and, additionally or alternatively, a behavior of a person identified in the image data.

Moreover, in accordance with one exemplary embodiment, first image data can be compared with second image data, which are recorded offset by a time interval in relation to the first image data, in the comparison step 120 in order to determine the difference between values of at least one pixel represented in the first image data and in the second image data. Here, in the comparison step 120, the monitoring information can be generated dependent on a comparison of the difference with a threshold. The threshold can be related to the time interval, to a maximum value of the at least one pixel, to a minimum value of the at least one pixel, to a value gradient of the at least one pixel, to a mean value of a plurality of pixels and, additionally or alternatively, to a position of the at least one pixel.

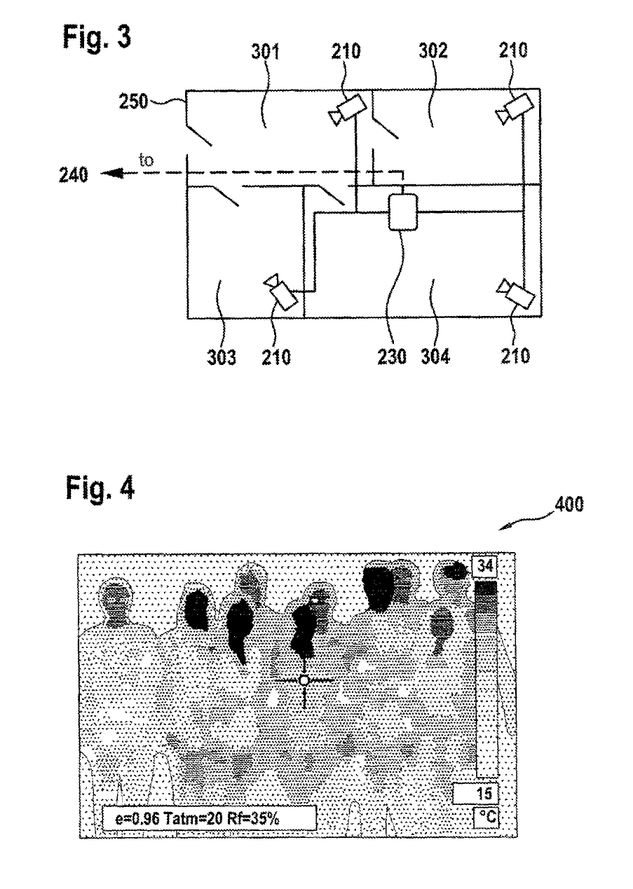

FIG. 2 shows a schematic illustration of an assistance system 200 for at least one interior space of a building in accordance with one exemplary embodiment of the present disclosure. Of the assistance system 200, all that is shown here in an exemplary and representation-dependent manner is a camera 210, a device 220 for monitoring at least one interior space of a building, a base station 230 and a server 240. Furthermore, a building 250 is shown in FIG. 2. The device 220 is embodied to carry out the steps of the monitoring method from FIG. 1. Even if this is not shown explicitly in FIG. 2, the device 220 can include suitable apparatuses which are embodied to carry out the steps of the monitoring method from FIG. 1.

In accordance with the exemplary embodiment of the present disclosure depicted in FIG. 2, the assistance system 200 includes the camera 210, the device 220, the base station 230 and the server 240. Here, the camera 210, the device 220 and the base station 230 are arranged in the building 250. The server 240 is arranged with spatial separation or at a distance from the building 250. In accordance with one exemplary embodiment, the assistance system 200 includes a plurality of cameras 210.

By way of example, the camera 210 is embodied as an infrared camera. Here, the camera 210 is arranged in an interior space or room (which has not been shown merely for representation-dependent reasons) of the building 250. The camera 210 is embodied for recording and providing image data. Moreover, the camera 210 is connected to the device 220 in a data transmission-capable manner, for example by means of a communication interface in the form of a wire, a wireless connection or the like. The device 220 is connected to the camera 210 and the base station 230 in a data transmission-capable manner, for example by means of communication interfaces in the form of wires, wireless connections or the like. Here, the base station 230 is connected to the device 220 and the server 240 in a data transmission-capable manner, for example by means of communication interfaces in the form of wires, wireless connections or the like. Even though this is not explicitly shown in FIG. 2, the server 240 can be connectable to at least one further base station of at least one further building in a data transmission-capable manner.

In accordance with the exemplary embodiment of the present disclosure depicted in FIG. 2, the device 220 is embodied as an independent device. In accordance with other exemplary embodiments, the device 220 can be embodied or designed as part of the at least one camera 210 or as part of the base station 230 or as part of the server 240, wherein the at least one camera 210 and the base station 230 are connected directly to one another in a data transmission-capable manner.

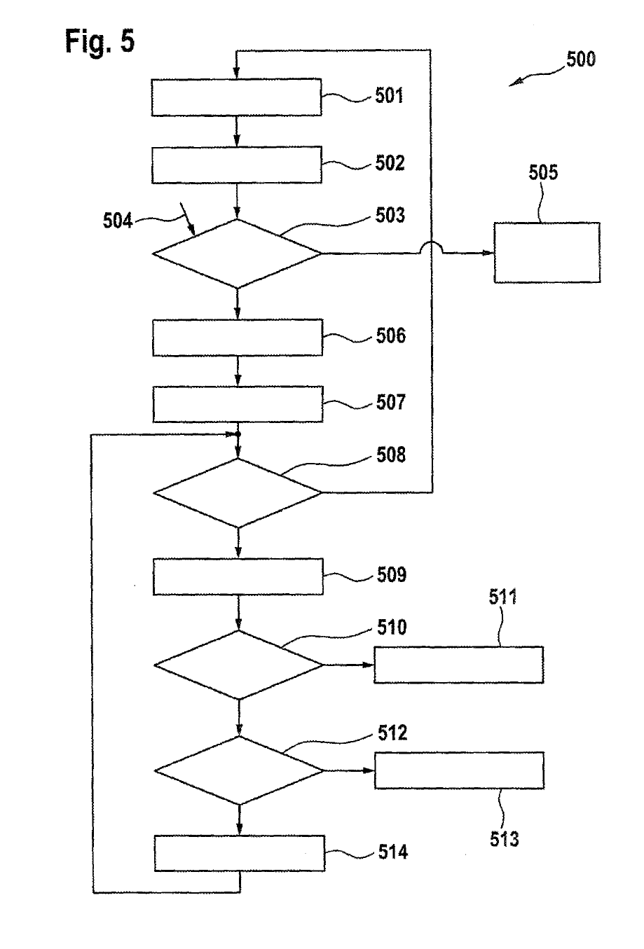

FIG. 3 shows a schematic illustration of an assistance system for at least one interior space of a building in accordance with one exemplary embodiment of the present disclosure in a building. Here, the assistance system is an assistance system similar to the assistance system from FIG. 2. Here, of the assistance system in FIG. 3, four cameras 210, a base station 230 and a line to a server 240 are shown in merely an exemplary manner. Furthermore, what is shown is a building 250, which is e.g. a domicile, with—in merely an exemplary manner—four rooms or interior spaces 301, 302, 303 and 304. In accordance with the exemplary embodiment of the present disclosure depicted in FIG. 3, the device for monitoring at least one interior space of a building can be embodied as part of the cameras 210, the base station 230 or the server 240.

A first one of the cameras 210 is arranged in a first interior space 301 and embodied for recording and providing image data which represent or depict the first interior space 301. A second one of the cameras 210 is arranged in a second interior space 302 and embodied for recording and providing image data which represent or depict the second interior space 302. A third one of the cameras 210 is arranged in a third interior space 303 and embodied for recording and providing image data which represent or depict the third interior space 301. A fourth one of the cameras 210 is arranged in a fourth interior space 304 and embodied for recording and providing image data which represent or depict the fourth interior space 304. By way of example, the first interior space 301 is a hall, the second interior space 302 is a bedroom, the third interior space 303 is a bathroom and the fourth interior space 304 is a kitchen diner or a living room with an open plan kitchen.

In accordance with the exemplary embodiment of the present disclosure depicted in FIG. 3, the base station 230 is arranged in the fourth interior space 304. The base station 230 is connected to each one of the cameras 210 in a data transmission-capable manner. More precisely, the base station 230 is embodied to receive image data from each one of the cameras 210 when the monitoring device is embodied in the base station 230 or in the server 240. If the monitoring device is embodied in the cameras 210, the base station 230 is embodied for receiving processed image data, e.g. monitoring information, warning information and/or action information, from the cameras 210. Moreover, the base station 230 is connected to the server 240 in a data transmission-capable manner, which is merely indicated in FIG. 3 for representation-dependent reasons.

In accordance with one exemplary embodiment, the cameras 210 are embodied as infrared cameras. Expressed differently, the cameras 210 or the optical sensors are based on infrared camera modules. Here, the cameras 210 or infrared cameras are preferably sensitive in the far infrared range. Far infrared sensors detect, in particular, inherent thermal radiation from persons and objects, i.e. a received signal or recorded image data is/are dependent on the temperature of an emitting surface.

Expressed differently, FIG. 3 shows a building 250 or a domicile with an installed assistance system or camera system. Here, FIG. 3 shows a domicile consisting of a hall 301, bathroom 303, bedroom 302 and living room 304 with an open plan kitchen. Respectively one optical sensor or one camera 210 is installed in each one of the rooms or interior spaces 301, 302, 303 and 304. The sensors or cameras 210 are connected to the base station 230 of the assistance system, which has an embodiment similar to an emergency home call system, by means of wires or a wireless connection, e.g. by means of WLAN, Bluetooth, ZigBee. The base station 230 is connected to the server 240, which, for example, can be embodied in the Internet, as part of a switchboard, etc., for example by means of a telecommunication connection, e.g. analog, by Ethernet, GSM, 3G, etc. Each one of the cameras 210 for example includes at least one optical sensor, a lens, a computer unit, e.g. a microcontroller, ASIC or the like, an energy supply, e.g. a power connection, a battery or the like, and a communication unit, e.g. a wired connection, WLAN, Bluetooth, ZigBee or the like. The cameras 210 are embodied to record images, in particular infrared images, of the interior spaces 301, 302, 303 and 304. The images are represented by image data. By way of example, these image data are filtered, analyzed and interpreted by image processing algorithms. Such image processing can be carried out in the monitoring device and can take place in the cameras 210 themselves, in a separate instrument, in the base station 230 or at the server 240. In accordance with one exemplary embodiment, the server 240 can also be arranged locally rather than remotely. The interpreted image signal or e.g. monitoring information, e.g. “lifeless person identified”, can serve as input signal for assistance functions and/or further assistance systems.

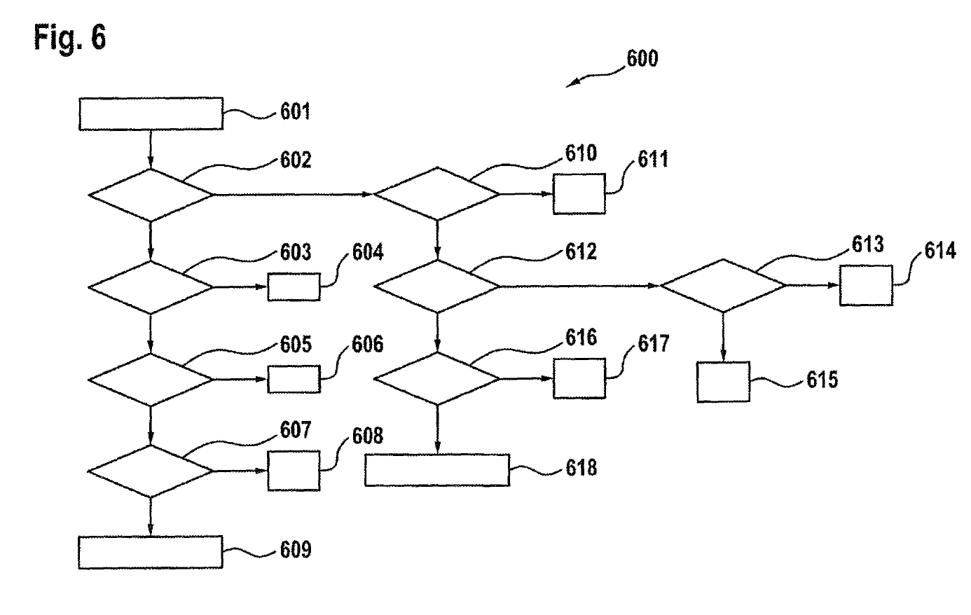

FIG. 4 shows an image 400 recorded by an infrared camera or an image of an infrared sensor. The image 400 or thermal image in this case shows a plurality of persons—10 persons in merely an exemplary manner. One of the cameras from FIG. 2 or FIG. 3 can be embodied to record an image like the image 400. Therefore, the image 400 may have been recorded by one of the cameras from FIG. 2 or FIG. 3. In FIG. 4, different temperature patterns, which correspond to the different persons, are identifiable in the image 400.

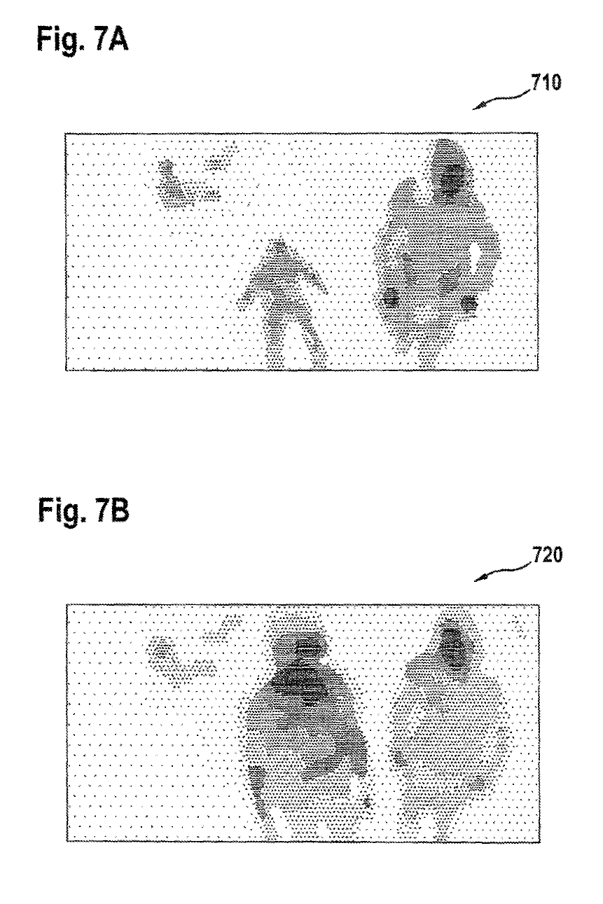

FIG. 5 shows a flowchart 500 for object identification in a method for monitoring at least one interior space of a building in accordance with one exemplary embodiment of the present disclosure. Here, a process of object identification depicted in the flowchart 500 can be carried out as part of the monitoring method from FIG. 1. The process of object identification, shown in the flowchart 500, represents a cyclical process.

The process of object identification, exemplified in the flowchart 500, includes a block 501, in which image recording takes place. Subsequently, image preprocessing or image segmentation takes place in a block 502. In a branching block 503, to which an optional entry 504 into the process leads, a determination is performed as to whether there is a large change in image data statistics. If there is a large change in the image data statistics, block 503 is followed by block 505, in which there is further processing dependent on the application case or dependent on the use case. If there is no large change in the image data statistics, block 503 is followed by block 506, in which a number N of objects is determined in the image data.

This is followed by block 507, in which an index i is set to 1 (i:=1). In a subsequent branching block 508, a check is carried out as to whether the index i is less than or equal to the number N of objects (i≦N). If this condition is not satisfied, the process returns to the image recording in block 501. If the condition is satisfied, block 508 is followed by block 509, in which a classification and, optionally, object tracking is performed for the object with the index i.

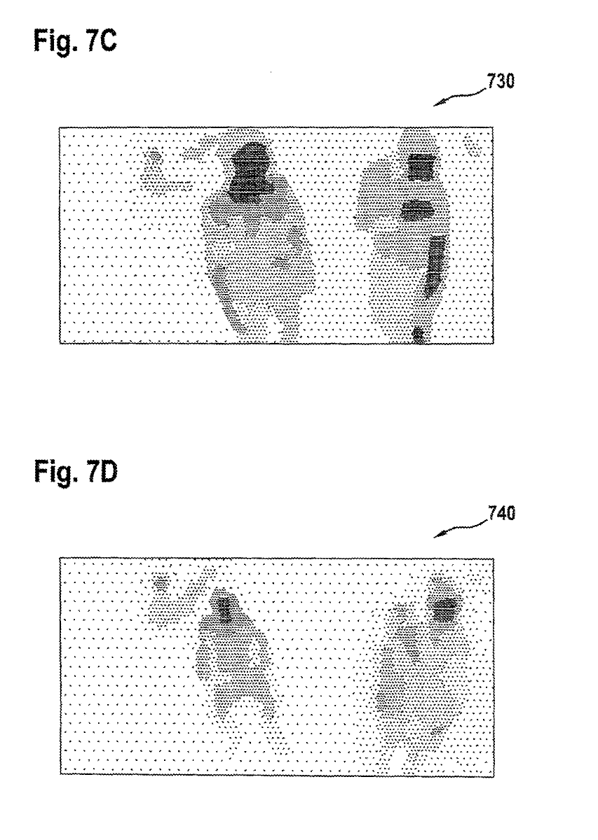

Subsequently, this is followed by a branching block 510, in which a decision is made as to whether the object is an animal. If the object is an animal, the process continues from block 510 to block 511, in which there is special further processing for the animal case. If the object is not an animal, block 510 is followed by a branching block 512, in which a decision is made as to whether the object is a human. If the object is a human, the process continues from block 512 to block 513, in which there is special further processing for the human case. Block 513 can lead to a process shown in FIG. 6 or it can include same. If the object is not a human, block 512 is followed by block 514, in which the index i is increased by one (i:=i+1). Subsequently, there is a jump from block 514 to in front of block 508.

In a much simplified implementation, it would likewise be possible to emit blocks 506 to 514 and to return directly to block 501 after block 503, i.e. only evaluate the image data statistics with a corresponding reaction.

As a result of correction of the return position, the sequence of 506 and 507 is irrelevant. Therefore, it would also be possible to combine 506 and 507 into one block.

FIG. 6 shows a flowchart 600 for classifying situations in a method for monitoring at least one interior space of a building in accordance with one exemplary embodiment of the present disclosure. Here, a process of classifying situations, exemplified in the flowchart 600, can be carried out as part of the monitoring method from FIG. 1 and, optionally, in combination with the process of object identification from FIG. 5.

The process of classifying situations depicted in the flowchart 600 can include the block of special further processing for the human case, shown in FIG. 5, as an entry point or start. Here, the process of classifying situations depicted in the flowchart 600 is dependent on a respective application. Decisions at branching points in this case occur on the basis of a set of rules or a classifier.

In block 601 there is a classification of a body position. In a subsequent branching block 602, a check is carried out as to whether a person is lying. If, in block 602, a determination shows that the person is lying, a branching block 603 follows, in which a check is carried out as to whether the person is lying at an untypical spot. If the person is lying at an untypical spot, the process continues from block 603 to block 604, in which an alarm is triggered. If the person is not lying at an untypical spot, the process continues from branching block 603 to branching block 605, where a determination is carried out as to whether there is a large decrease in the body temperature of the person. If this is answered in the affirmative, an alarm is triggered in block 606. However, if there is no strong decrease in the body temperature, branching block 605 is followed in the process by branching block 607, in which a check is carried out as to whether the person is e.g. upright in bed and/or whether said person's feet are on the floor. If this is answered in the affirmative, there is further processing—dependent on application—in block 608 and e.g. an alarm is triggered or a light is switched on. If the check in branching block 607 leads to a negative result, the cyclical process is continued in block 609. The sequence of blocks 603, 605 and 607 is only exemplary and can be varied as desired.

If, in branching block 602, a determination shows that the person is not lying, the process continues at branching block 610, in which a check is carried out as to whether a person enters the room. If this is the case, there is further processing—dependent on application—in block 611. If no person enters the room, branching block 610 is followed by branching block 612, in which a determination is carried out as to whether the person leaves the room or the building or the domicile. The sequence of blocks 610, 612 and 616 is only exemplary and can be varied as desired.

If the determination in block 612 is answered in the affirmative, there is establishment in branching block 613 as to whether a temperature distribution is conspicuous and/or whether a piece of clothing is inadequate. If this is the case, an alarm for a control room or a warning to a person is triggered in block 614. If the temperature distribution is inconspicuous and/or if the clothing is adequate, there is further processing—dependent on application—in block 615.

If the determination in block 612 is answered in the negative, a check is carried out in branching block 616 as to whether a temperature distribution is conspicuous and/or whether the clothing is wet. If this is the case, an alarm for a control room or a warning to a person is triggered in block 617. If the temperature distribution is inconspicuous and/or if the clothing is not wet, there is a continuation of the cyclical process in block 618.

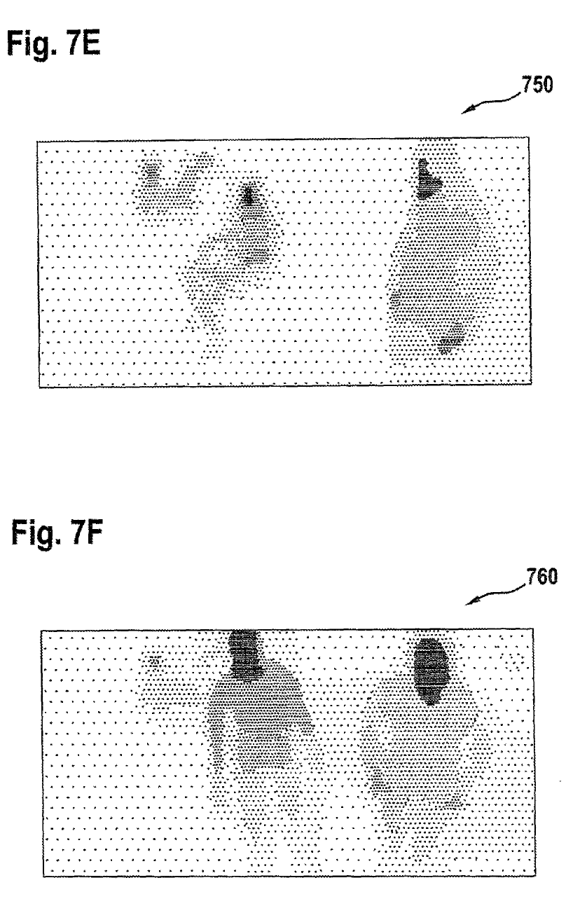

FIGS. 7A to 7F show images of persons in different situations, recorded by an infrared camera. One of the cameras from FIG. 2 or FIG. 3 can be embodied to record images like the images from FIGS. 7A to 7F. Therefore, the images from FIGS. 7A to 7F may have been recorded by one of the cameras from FIG. 2 or FIG. 3. Furthermore, the images from FIGS. 7A to 7F or the image data underlying the images can be used by a method such as the monitoring method from FIG. 1 and, optionally, by at least one of the processes from FIG. 5 and FIG. 6. Expressed differently, FIGS. 7A to 7F show recordings of two persons in various situations, taken by an infrared camera. Image processing algorithms of the method from FIG. 1 or of the processes from FIG. 5 and FIG. 6 are embodied to identify the situations on the basis of these images.

FIG. 7A shows a thermal image 710 of two persons, of which the person imaged on the left-hand side in the figure is seated and the person imaged on the right-hand side in the figure is standing. FIG. 7B shows a thermal image 720 of two standing persons. FIG. 7C shows a thermal image 730 of two persons, of which the person depicted on the right-hand side in the figure is just in the process of rolling up one sleeve.

FIG. 7D shows a thermal image 740 of two persons, of which the person imaged on the left-hand side in the figure is seated, in a frontal view. FIG. 7E shows a thermal image 750 of two persons, of which the person imaged on the left-hand side in the figure is seated, in a side view. FIG. 7F shows a thermal image 760 of two persons, of which the person imaged on the left-hand side in the figure is upstanding again.

With reference to FIGS. 1 to 7F, various exemplary embodiments of the present disclosure are explained in a summarizing manner and in different words in the following text.

In accordance with one exemplary embodiment, at least one camera 210 or device 220 is used for implementing an assistance system 200 which reliably identifies the current situation of occupants of a building 250 (“situational awareness”). A process of identifying the occupants by the at least one camera 210, the device 220 or the assistance system 200 is depicted in FIG. 5. A goal for the assistance system 200 is e.g. the earliest possible identification of inactivity or identification of deviations of previously analyzed or learned activity defined as normal. As a result of this, it is possible not only to trigger an alarm if no activity is determined, but also to identify this separately for a plurality of persons. Moreover, an early warning, when this still gives activity but it deviates from activity defined as normal, is possible. The assistance system 200 is not impeded, or only impeded minimally, by pets. In addition to identifying activity, the following situations can be identified here: whether a person enters the space, whether a person leaves the space, how many persons are situated in a space, which person is situated in a space, and identification of pets in the space. By way of example, identifying a person number and identifying pets is carried out in accordance with the process depicted in FIG. 5. Provided there is a sufficient resolution, various persons can be separated relatively easily from one another since typical contours of persons can easily be identified in the thermal image, as is identifiable in FIG. 4 or 7A to 7F. Recognition or identification of e.g. a plurality of persons in a household is realizable by calibration of the persons. Once this has taken place, persons can be identified by individually different distributions of the skin temperature.

In accordance with one exemplary embodiment, at least one camera 210 or device 220 is used for implementing an assistance system 200 which reliably identifies fallen or motionless persons and triggers an alarm. A functionality of identifying such a situation for example follows the process depicted in FIG. 6. Unlike the case where ultrasound or radar is used, a person can also be identified if they are not moving in the case where a thermal image is used. By way of example, a person fallen as a result of a seizure can be detected in the thermal image as a person lying at a spot not provided for this, particularly in order to distinguish them from a scenario where an occupant e.g. lies on a couch and sleeps. In principle, it is also possible to monitor a vitality state with the aid of continuous monitoring of the object or the occupant. Thus, by carrying out the monitoring method 100, it is identifiable that, in the case of an unchanging temperature of the surroundings, the body temperature of a human only reduces a little during sleep in a manner dependent on the temperature of the surroundings, whereas e.g. a circulatory collapse leads to a comparatively clear and rapid fall in the body temperature.

In accordance with one exemplary embodiment, at least one camera 210 or device 220 is used for implementing an assistance system 200 for persons who are at great risk of falling, which assistance system can e.g. identify getting-up processes out of a bed, from a chair or a sofa and can then alert care staff. The care staff can then accompany the person to the goal, e.g. bathroom, kitchen, in order to minimize the risk of falling. Illumination can also be switched on on the basis of the monitoring information. The assistance system 200 can be embodied to derive a getting-up process e.g. from a combination of the sitting-up and feet-on-the-floor person-related events, comparable with the process from FIG. 6. When an occupant gets up, there is, firstly, a clear change in form of the so-called hotspot in the thermal image and, secondly, a positional displacement within a short time interval. The assistance system 200 can be embodied to evaluate this statistically in the overall image, wherein there is no need to use highly developed image identification algorithms and wherein the image data and the monitoring information depend on the respective scenario. In the simple case of a person who, for example, sat on a chair in a living room at normal temperature for a relatively long time—see e.g. FIG. 7D and FIG. 7E—, a portion of warm pixels, i.e. pixels with values representing a high temperature, is higher in the image directly after standing up than prior to standing up because the chair has significantly heated up and therefore emits more thermal radiation than an upper side of the person who was previously sitting thereon, see e.g. FIG. 7F. If a mean value of all pixels of the image data is formed here in the monitoring method 100 and followed over time, the mean value will jump up significantly during such a getting-up process.

In accordance with one exemplary embodiment, at least one camera 210 or device 220 is used for implementing an assistance system 200 which is embodied to monitor activities of daily life. By way of example, this includes time and duration of personal hygiene, e.g. washing hands in the washbasin in the bathroom, taking in hot meals, e.g. eating at the table, using kitchen implements, such as stove, refrigerator, sink, etc., and time and duration of social contacts, e.g. visits, and monitoring of therapies, e.g. regular running exercises in the case of persons with a limp. By means of sensor information or the image data, such activities are quantifiable by the assistance system 200 or the monitoring method 100. Additionally, the assistance system 200 or the method 100 can check a state of the clothing. In particular, an evaporating liquid leads to a local temperature decrease in the region of an outer surface of the clothing. This is detectable to the assistance system 200 as a change in image data. Therefore, the assistance system 200 can be embodied to identify wetness due to spilled liquids during food intake, e.g. drinks, liquid food, or due to incontinence, wherein the process from FIG. 6 can also be used for this purpose. Additionally, by linking with external information or surroundings information, the assistance system 200 can be embodied to identify whether occupants are suitably dressed in accordance with current weather conditions outside of the building 250 or in accordance with the temperature within the building 250. By way of example, the assistance system 200 can be embodied to check whether e.g. coat and shoes are worn when leaving the building 250. Such monitoring information can be compared with data of a weather forecast, e.g. from the Internet, wherein this can also take place in conjunction with the process from FIG. 6. By way of example, parts of the body insufficiently covered with clothing are identifiable in a whole-body thermal image as a result of their increased temperature in the building 250, as can be seen in FIG. 7C. In particular, in the image data, a jacket practically has room temperature directly after being put on, whereas e.g. a T-shirt worn on the body is identifiable as being warmer.

In accordance with one exemplary embodiment, at least one camera 210 or device 220 is used for implementing an assistance system 200 which is embodied to identify risks. By way of example, an alarm can be triggered if burning articles, such as candles, cigarettes, etc., or active electric appliances, e.g. iron, stove, television, are identified and there was simultaneous detection that no person is situated in the domicile or the building 250. An alarm may also be triggered when specific temperature thresholds, e.g. 140° C., are exceeded. Moreover, a warning in relation to hot water, e.g. from a kettle or hot shower water, or in relation to food and drink that is too hot, is possible. Additionally, the at least one camera 210 or device 220 can be used to detect a presence of unauthorized persons in the building 250. An unauthorized person can be identified by recognition/non-recognition or identification by image processing, unusual behavior or panic by the occupant/occupants and/or by an unusual situation, for example if a person enters the building 250 even though no further person is expected at this time and this day of the week.

In accordance with one exemplary embodiment, the assistance system 200 is usable as a mobile assessment system. What this means is that an assistance system 200 comprising a suitable number of cameras 210 and a recording apparatus is set up for a certain period of time with a person in a building. Recorded monitoring information is employable to determine how much, and what type of, help this person is to receive, e.g. for estimating the care stage.

In accordance with one exemplary embodiment, the at least one camera 210 or device 220 of the assistance system 200 is employable as a movement motivator, like in the case of video games. Using this, movements/activity can be fed back interactively for analyzing an activity and for motivating a user.

Considered overall, the described monitoring method 100 or the assistance system 200 inter alia constitutes an essential improvement of the so-called situational awareness. Here, an improved automatic identification of monitoring-relevant situations can be achieved, such as e.g. leaving, and returning to, a domicile. The situational awareness can also be improved for households comprising more than one person. It is possible to identify not only inactivity (situational awareness) but also deviations of activities from a defined or learned normal case, such as e.g. slower, quicker, other running routes, etc. Moreover, additional assistance and comfort functions can be realized in conjunction with the monitoring method 100 or the assistance system 200, such as e.g. a robust fall identification and identification of motionless persons, an identification of getting-up processes, e.g. from a bed, for notifying care staff or for controlling the light to minimize the risk of a fall, e.g. when going to the bathroom, i.e. going to the bathroom with attendants, monitoring of activities of daily living (ADL) such as e.g. personal hygiene, food intake, social interactions, e.g. the number of contacts with other persons, furthermore alarm systems on the basis of the measurement of temperatures, e.g. body temperature, temperature of articles and appliances, e.g. the stove, for a fire alarm or the like, a light or heating control depending on persons present, monitoring of whether, and for how long, windows and doors are open, and an identification of activities such as movement, movement speed, body posture, and therefore also the possibility of providing a warning in the case of deviations from normal behavior/normal situations, or else for transmitting a request to a user to modify a behavior or situation. The monitoring method 100 or the assistance system 200 can also find use for identifying gestures (for example, but not restricted to, in the dark as well), e.g. for triggering an emergency call if the monitoring shows that a person can no longer get up.

The exemplary embodiments, which are described and shown in the figures, are only selected in an exemplary manner. Different exemplary embodiments can be combined with one another, either completely or in relation to individual features. Also, an exemplary embodiment can be complemented by features of a further exemplary embodiment.

Furthermore, the method steps presented here can be carried out repeatedly and in a different sequence to the one described.

If an exemplary embodiment comprises an “and/or” link between a first feature and a second feature, this should be read in such a way that the exemplary embodiment includes both the first feature and the second feature in accordance with one embodiment and includes either only the first feature or only the second feature in accordance with a further embodiment.

What is claimed is:

1. A method for monitoring at least one interior space of a building, comprising:
comparing recorded image data representing the at least one interior space with reference data representing a reference situation, in order to generate monitoring information dependent on a comparison result, the monitoring information representing a monitoring-relevant situation in the at least one interior space.

2. The method according to claim 1, wherein the comparing recorded image data further comprises:
using infrared image data recorded by an infrared camera as the recorded image data.

3. The method according to claim 1, wherein the reference data represent at least one object pattern and the comparing recorded image data further comprises:
identifying at least one object represented by the image data, the at least one object representing a person, an animal, and/or an article.

4. The method according to claim 3, wherein the recorded image data includes first image data and second image data and the comparing recorded image data further comprises:
determining a position, a movement, a speed, and/or a behavior of a person identified in the image data by comparing the first image data with the second image data,
wherein the first image data and the second image data are recorded offset by a time interval in relation to the first image data.

5. The method according to claim 1, wherein the recorded image data includes first image data and second image data and the comparing recorded image data further comprises:
determining a difference between values of at least one pixel represented in the first image data and in the second image data by comparing the first image data with the second image data; and
generating the monitoring information dependent on a comparison of the difference with a threshold,
wherein the first image data and the second image data are recorded offset by a time interval in relation to the first image data.

6. The method according to claim 5, wherein the threshold is related to the time interval, to a maximum value of the at least one pixel, to a minimum value of the at least one pixel, to a value gradient of the at least one pixel, to a mean value of a plurality of pixels, and/or to a position of the at least one pixel.

7. The method according to claim 1, further comprising:
generating the reference data using predefined pattern data, compared image data, at least one item of the monitoring information, and/or surroundings data of the at least one interior space.

8. The method according to claim 1, further comprising:
emitting warning information and/or action information configured to rectify the monitoring-relevant situation dependent on the monitoring information.

9. The method according to claim 1, wherein a device is configured to perform, implement, and/or actuate the method.

10. The method according to claim 1, wherein a computer program is configured to perform the method.

11. The method according to claim 10, wherein a machine-readable storage medium comprises the computer program stored thereon.

12. An assistance system for at least one interior space of a building, comprising:
at least one camera located in the at least one interior space, the at least one camera configured to record image data; and
a device connected to the at least one camera in a data transmission-capable manner, the device configured to perform, implement, and/or actuate a method for monitoring the at least one interior space,
wherein the method includes comparing the recorded image data representing the at least one interior space, with reference data representing a reference situation, in order to generate monitoring information dependent on a comparison result, the monitoring information representing a monitoring-relevant situation in the at least one interior space.

13. The assistance system according to claim 12, wherein the device is embodied as part of the at least one camera or as a separate device which is separate from the at least one camera.

14. The assistance system according to claim 12, further comprising:
a base station located in the building and connected to the at least one camera in a data transmission-capable manner; and
a server arranged separately from the building and connected to the base station in a data transmission-capable manner,
wherein the device is embodied as part of the base station or as part of the server.
